(19) United States
(12) Patent Application Publication
(10) Pub. No.: US 2024/0295254 A1
(43) Pub. Date: Sep. 5, 2024

(54) LINK PLATE AND CHAIN

(71) Applicant: TSUBAKIMOTO CHAIN CO., Osaka (JP)

(72) Inventors: Daisuke Nakao, Osaka (JP); Masahiro Koyama, Osaka (JP); Shouta Miyanaga, Osaka (JP)

(73) Assignee: TSUBAKIMOTO CHAIN CO., Osaka (JP)

(21) Appl. No.: 18/422,096

(22) Filed: Jan. 25, 2024

(30) Foreign Application Priority Data
Mar. 2, 2023 (JP) 2023-031838

(51) Int. Cl. F16G 13/07

(52) U.S. Cl. CPC F16G 13/07

(57) ABSTRACT

To provide a versatile and easy-to-produce link plate that can mitigate the rise in surface pressure on guide members even when the link plate is slightly tilted, to minimize adverse effects of wear marks and wear particles, and a chain. The link plate has a sliding end face, with end face rounded portions at both ends in a direction of plate thickness, formed to be continuous with both side faces of the link plate. The link plate is shaped to satisfy 16.8≥((r*2/t²)+(t−r*2))/r≥11.5, where r represents a minimum radius of curvature of the end face rounded portions and “t” represents the plate thickness of the link plate.

### BACKGROUND OF THE INVENTION

### 1. Field of the Invention

The present invention relates to a link plate wherein connecting pins pivotably couple the link plates together to form a chain, each link plate having a sliding end face at least on one side in an up and down direction for sliding contact with a chain guide.

### 2. Description of the Related Art

Link plates that make up roller chains, bushing chains, or silent chains used in power transmission mechanisms of automobiles, industrial machines and the like are conventionally known. A link plate has connection holes at front and rear ends and a sliding end face that makes sliding contact with a guide member.

In a common chain, the sliding end face, or the end face on the guided side of each link, is entirely flat in the area between the centers of the connection holes at the front and rear ends in the chain running direction (chain pitch section). Therefore, when the guide member in sliding contact with the chain has a flat surface or a surface with a large radius of curvature, the surface pressure is low but the friction resistance is high.

Chains designed to reduce friction resistance have been known, in which the link plates have a concavely curved portion in the end face on the guided side, or an irregular shape such as a bilaterally asymmetrical design, to control the supply of lubricating oil (for example, see Japanese Patent Application Publications Nos. 2009-019749, H11-236949, 2010-249240, 2011-231822, etc.).

Also known are chains with link plates having an end face on the guided side that is convexly rounded along the running direction of the chain when viewed from the side. This shape not only helps reduce the friction resistance but also ensures the plate strength around the connection holes and guarantees the strength to withstand tension (see, for example, Japanese Patent Application Publication No. 2012-255523).

### SUMMARY OF THE INVENTION

While the known link plates such as those described in Japanese Patent Application Publications Nos. 2009-019749, H11-236949, 2010-249240, 2011-231822, etc. allow for optimization of surface pressure and friction resistance, they need to be designed differently according to the environment in which they are used, because the surface pressure and friction resistance vary largely depending on the viscosity and temperature of the lubricating oil, as well as the surface condition of the guide member. The link plates must be produced precisely as designed, which lowers the versatility and increases the production cost.

The link plate known from Japanese Patent Application Publication No. 2012-255523 significantly reduces the friction resistance. On the other hand, the surface pressure on the guide member is high, because of which measures were necessary to eliminate adverse effects of wear marks and wear particles.

Another problem was that the maximum height of the link plate had to be set larger than necessary to enhance the plate strength around the connection holes.

The present applicants have proposed the link plate known from Japanese Patent Application Publication No. 2020-200863 as a solution to these problems.

These known link plates are assembled into a chain with a slight clearance so as to allow for smooth bending, because of which the link plates sometimes slightly tilt due to vibration or the like.

When tilted, the sliding end face makes contact only at both ends in the plate thickness direction, increasing the surface pressure on the guide member. However, these known link plates have no measures to prevent the adverse effects of wear marks and wear particles that may be produced by the increased surface pressure.

The present invention solves the problems encountered by the prior art described above and provides a versatile and easy-to-produce link plate that can reduce the wear that develops on a guide member over time and mitigate the rise in surface pressure on the guide member even when the link plate is slightly tilted, to minimize adverse effects of wear marks and wear particles, and a chain.

The present invention achieves the above object by providing a link plate wherein connecting pins pivotably couple the link plates together to form a chain, each link plate having a sliding end face at least on one side in an up and down direction for sliding contact with a chain guide, the sliding end face including end face rounded portions at both ends in a direction of plate thickness of the link plate, the end face rounded portions formed to be continuous with both side faces of the link plate, the link plate shaped to satisfy 16.8≥((r*2/t²)+(t−r*2))/r≥11.5, where r represents a minimum radius of curvature of the end face rounded portions and “t” represents the plate thickness of the link plate.

The link plate according to claim 1 is shaped to satisfy 16.8≥((r*2/t²)+(t−r*2))/r≥11.5, where r represents a minimum radius of curvature of the end face rounded portions and “t” represents the plate thickness of the link plate. This design makes the link plate versatile and easy-to-produce, and reduces the wear that develops over time on guide members. The design also helps mitigate the rise in surface pressure on guide members even when the link plate is slightly tilted, so that adverse effects of wear marks and wear particles can be minimized.

When ((r*2/t²)+(t−r*2))/r is smaller than 11.5, the contact area with the guide member reduces due to the relatively shorter distance between the end face rounded portions on both sides, resulting in a rise in surface pressure. The high surface pressure may increase the amount of wear on the guide member over time.

When ((r*2/t²)+(t−r*2))/r is larger than 16.8, the contact area with the guide member increases due to the relatively larger distance between the end face rounded portions on both sides, which may lead to an increase in friction resistance.

Moreover, the relatively smaller radius of the end face rounded portions may cause a large increase in surface pressure when the link plate is tilted. In this case, the adverse effects of wear marks and wear particles may not fully be prevented.

The configuration set forth in claim 2 effectively reduces the wear that develops over time on guide members, and helps minimize adverse effects of wear marks and wear particles.

When “t” is larger than 1.65 mm, the inclination of link plates caused by vibration or the like is kept small, so that the guide member is less affected by a rise in surface pressure.

“t” being smaller than 0.80 mm means that the chain is being used in a system under a small tension. The guide member in such a system is relatively more resistant to wear and impact and less affected by a rise in surface pressure.

The configuration set forth in claim 3 helps introduce more lubricating oil to contacting parts, thereby more effectively reducing the wear that develops over time on guide members, and minimizing adverse effects of wear marks and wear particles.

According to the chain set forth in claim 4, only the inner link plates make contact with the guide member. The number of link plates with end face rounded portions that need to be machined can thus be decreased, which makes the overall production of the chain easier.

According to the chain set forth in claim 5, a large number of link plates stacked in the width direction and making contact with the guide member at the same time can reduce the overall surface pressure. The number of link plates with end face rounded portions that need to be machined can thus be decreased, which makes the overall production of the chain easier.

### BRIEF DESCRIPTION OF THE DRAWINGS

FIG. 1 is a perspective view of a part of a chain according to a first embodiment of the present invention;

FIG. 2 is a side view of an inner link plate in the chain shown in FIG. 1;

FIG. 3 is a cross-sectional view of the chain of FIG. 1;

FIG. 4 is a test graph indicating a relationship between link plate inclination and surface pressure; and

FIG. 5 is a test graph indicating a relationship between the minimum radius of curvature r of rounded portions on the end face of the link plate and the amount of wear of a guide member.

### DESCRIPTION OF THE PREFERRED EMBODIMENTS

FIG. 1 shows a chain 100, designed as a roller chain and using the link plates that are one embodiment of the present invention as inner link plates 101.

The chain 100 includes pairs of left and right inner link plates 101, cylindrical bushings 103 with their both ends press-fit in bushing holes of the inner link plates 101, pairs of left and right outer link plates 102 disposed on both outer sides of the inner link plates 101, and connecting pins 104 rotatably inserted in the bushings 103 and having both ends press-fit in pin holes of the outer link plates 102. A large number of these inner link plates 101 and outer link plates 102 are alternately coupled together by the connecting pins 104 along the longitudinal direction of the chain.

The inner link plate 101 is symmetrical both vertically and bilaterally as shown in FIGS. 1, 2, and 3, and has a sliding end face 120 at the top and bottom for sliding contact with a guide member. The sliding end face extends parallel to the line that connects the centers of the front and rear bushing holes 111.

The sliding end face 120 includes end face rounded portions 121 at both ends in the plate thickness direction of the inner link plate 101, which are formed to be continuous with both side faces.

In this embodiment, the sliding end face 120 is convexly rounded along the running direction of the chain when viewed from the side of the link plate.

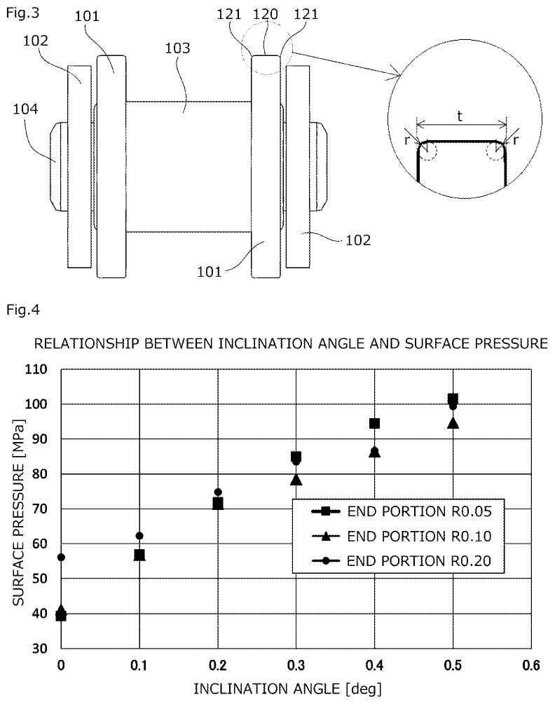

The link plate is formed to satisfy 16.8≥((r*2/t²)+(t−r*2))/r≥11.5, where r represents the minimum radius of curvature of the end face rounded portions 121 and “t” represents the plate thickness of the inner link plate, as shown in FIG. 3.

FIG. 4 shows a test data of the chain 100 designed as described above, indicating a relationship between the inclination angle of the inner link plate 101 and the surface pressure depending on the minimum radius of curvature r of the end face rounded portions 121.

The plate thickness “t” of the inner link plate 101 was 1.5 mm.

As is seen from FIG. 4, when the minimum radius of curvature r of the end face rounded portions 121 is as small as 0.05 mm, the surface pressure is low when the inclination angle is 0° because of the large distance between the end face rounded portions on both sides. The surface pressure grows as the inclination angle increases.

When the minimum radius of curvature r of the end face rounded portions 121 is as large as 0.20 mm, the surface pressure is high when the inclination angle is 0° because of the small distance between the end face rounded portions on both sides. The surface pressure grows in small increments as the inclination angle increases, but because the surface pressure when the inclination angle is 0° is high, the surface pressure when the inclination angle is 0.5° is more or less the same as that of when the end face rounded portions 121 have a minimum radius of curvature r of 0.05 mm.

When the minimum radius of curvature r of the end face rounded portions 121 is 0.1 mm, i.e., when ((r*2/t²)+(t−r*2))/r=13.89, the surface pressure increases similarly to when the end face rounded portions 121 have a minimum radius of curvature r of 0.05 mm. However, the increment of increase in surface pressure lowers when the link plate is inclined at an angle of more than 0.2°.

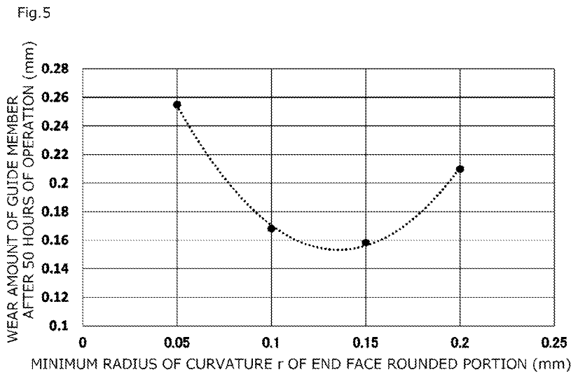

FIG. 5 shows a test graph of the chain 100 indicating a relationship between the minimum radius of curvature r of the end face rounded portions 121 of the inner link plate 101 and the amount of wear of the guide member after the chain 100 has been run for a long time.

The data indicates that, when the minimum radius of curvature r of the end face rounded portions 121 is as small as 0.05 mm, the guide member suffers severe wear due to the high surface pressure when the link plates are tilted, resulting in the large overall wear amount. With the minimum radius of curvature r of the end face rounded portions 121 being as large as 0.20 mm, the surface pressure is high even when the link plates are tilted at a small angle. This is considered to have caused prolonged and continued application of surface pressure, resulting in the large overall wear amount.

This relationship could be optimized by defining a relationship between the plate thickness “t” and the minimum radius of curvature r of the end face rounded portions 121. In determining such a relationship, it is necessary to add to consideration the changes in the flow conditions of lubricating oil depending on the plate thickness “t” and the minimum radius of curvature r of the end face rounded portions 121 as varying elements.

As a result of various tests, the inventors found out that (t−r*2)/r, i.e., the ratio of the length (t−r*2) of the main contact area between the end face rounded portions on both sides, to the minimum radius of curvature r of the end face rounded portions, is most suited to represent the relationship between the plate thickness “t” and the minimum radius of curvature r of the end face rounded portions 121.

Moreover, the inventors found a very high correlation between the value ((r*2/t²)+(t−r*2))/r and the amount of wear of the guide member after a prolonged time of operation. The above value is the sum of the correction term (r*2/t²)/r that represents the changes in the flow conditions of lubricating oil depending on the plate thickness “t” and the minimum radius of curvature r of the end face rounded portions, and the ratio (t−r*2)/r.

After a number of tests, the inventors came to a conclusion that the optimum numerical range is 16.8≥((r*2/t²)+(t−r*2))/r≥11.5.

While the embodiment described above is applied to the inner link plates 101, the outer link plates 102 that are brought into sliding contact with the guide member may also have a similar configuration.

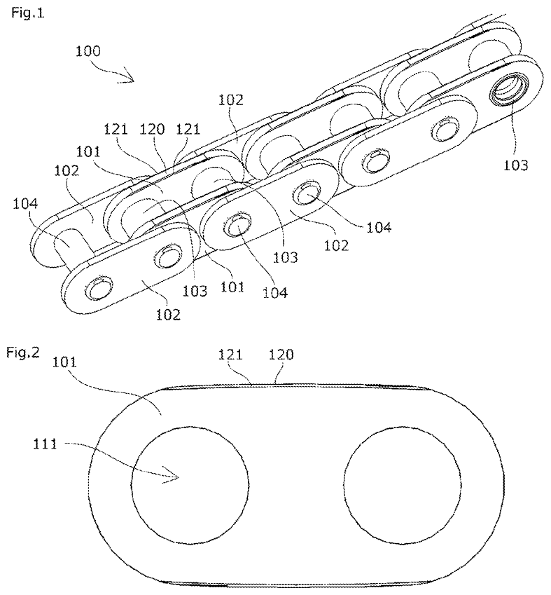

While the link plate has been described as being vertically and bilaterally symmetrical as viewed from one side as shown in FIG. 2, the link plate may be designed vertically asymmetrical so that it has the sliding end face only on one side to make contact with the guide member, such as when the link plate is used in a silent chain, for example.

Further, the link plate may be designed bilaterally asymmetrical in cases where the traveling direction is specified, or in order to make the characteristics in one traveling direction different from those in the other direction.

What is claimed is:

1. A link plate wherein connecting pins pivotably couple the link plates together to form a chain, each link plate having a sliding end face at least on one side in an up and down direction for sliding contact with a guide member,
the sliding end face including end face rounded portions at both ends in a direction of plate thickness of the link plate, the end face rounded portions formed to be continuous with both side faces of the link plate,
the link plate shaped to satisfy 16.8≥((r*2/t²)+(t−r*2))/r≥11.5, where r represents a minimum radius of curvature of the end face rounded portions and “t” represents the plate thickness of the link plate.

2. The link plate according to claim 1, wherein the plate thickness “t” of the link plate is 1.65 mm≥t≥0.80 mm.

3. The link plate according to claim 1, wherein the sliding end face is convexly rounded along a running direction of the chain when viewed from a side of the link plate.

4. A chain comprising a plurality of inner link plates and a plurality of outer link plates pivotably coupled together by connecting pins,
the inner link plates each being the link plate according to claim 1.

5. A chain comprising a plurality of link plates pivotably coupled together by connecting pins,
the link plates including not more than four link plates that are each the link plate according to claim 1 in a width direction.
